(19) United States
(12) Patent Application Publication
(10) Pub. No.: US 2014/0062902 A1
(43) Pub. Date: Mar. 6, 2014

(54) TOUCH PANEL

(71) Applicant: SAMSUNG ELECTRO-MECHANICS CO., LTD., Gyunggi-do (KR)

(72) Inventors: Seung Heon Han, Gyunggi-do (KR); Hee Soo Kim, Gyunggi-do (KR); Jung Eun Noh, Gyunggi-do (KR)

(73) Assignee: SAMSUNG ELECTRO-MECHANICS CO., LTD., Gyunggi-do (KR)

(21) Appl. No.: 13/663,332

(22) Filed: Oct. 29, 2012

(30) Foreign Application Priority Data
Aug. 29, 2012 (KR) 10-2012-0094787

(51) Int. Cl. G06F 3/041

(52) U.S. Cl. 345/173

(57) ABSTRACT

Disclosed herein is a touch panel, including an electrode formed in a pattern including continuous rectangles, and in first rectangles which are continuous in a first direction among the rectangles, first common sides and second common sides are alternately formed among the first rectangles, in second rectangles which are continuous in a second direction among the rectangles, third common sides and fourth common sides are alternately formed among the second rectangles, and the first common sides, the second common sides, the third common sides, and the fourth common sides are parallel to each other and have the same length as each other.

### CROSS REFERENCE TO RELATED APPLICATION

This application claims the benefit of Korean Patent Application No. 10-2012-0094787, filed on Aug. 29, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

With the development of a computer using digital technologies, auxiliary devices have also been developed together, and personal computers, portable transmitting apparatuses, other personal information processing apparatuses, and the like performs text and graphic processing by using various input devices such as a keyboard and a mouse.

However, with rapid progress of an information-oriented society, purposes of the computer tend to be gradually extended. Therefore, it is difficult to efficiently drive a product by only the keyboard and the mouse that serve the input devices at present. Accordingly, the necessity of an apparatus to be simple and less misoperated, and for anybody else to easily input information has been increased.

Further, in the case of a technology associated with the input device, a concern is changed to high reliability, durability, innovativeness, design and processing associated technologies over a level to satisfy a general function and in order to achieve the object, a touch panel is developed as an input device which is possible to input information such as texts, graphics, and the like.

The touch panel is a tool that is installed on a display surface of flat panel display devices such as an electronic notebook, a liquid crystal display device (LCD), a plasma display panel (PDP), and an electroluminescence (El) and an image display device such as a cathode ray tube (CRT), and is used for a user to select desired information while viewing the image display device.

Meanwhile, types of the touch panels include a resistive type, a capacitive type, an electro-magnetic type, a surface acoustic wave (SAW) type, and an infrared type. Various types of touch panels are adopted in electronic products by considering a problem in signal amplification, a difference in resolution, a difficulty in design and processing technology, an optical characteristic, an electrical characteristic, a mechanical characteristic, an environment resistant characteristic, an input characteristic, durability, and economics, and the types used in the widest ranges at present include the resistive type touch panel and the capacitive type touch panel.

Meanwhile, in the touch panel, a research of forming an electrode by using metal has been actively progressed as disclosed in Korean Patent Laid-Open Publication No. 10-2010-0091497. As such, when the electrode is made of metal, electrical conductivity is excellent, and a demand and a supply are smooth. However, when the electrode is made of metal, the touch panel needs to be formed in a mesh structure by the unit of micrometer (μm) in order to prevent the user from recognizing the electrode made of metal. However, when the electrode of the touch panel is formed in a mesh structure which is regular and has a predetermined interval, since a periodic characteristic between an electrode pattern of the touch panel and a black matrix pattern of a color filter provided in the image display device (LCD, and the like) is overlapped, a Moire phenomenon occurs, and as a result, visibility deteriorates.

### SUMMARY OF THE INVENTION

The present invention has been made in an effort to provide a touch panel that can prevent a Moire phenomenon from occurring, which includes an electrode with a pattern which has predetermined regularity, however, a pattern in which a continuous line is not formed in any direction.

According to a first preferred embodiment of the present invention, there is provided a touch panel, including: an electrode formed in a pattern including continuous rectangles, and in first rectangles which are continuous in a first direction among the rectangles, first common sides and second common sides are alternately formed among the first rectangles, in second rectangles which are continuous in a second direction among the rectangles, third common sides and fourth common sides are alternately formed among the second rectangles, and the first common sides, the second common sides, the third common sides, and the fourth common sides are parallel to each other and have the same length as each other.

The first common sides and the second common sides may not be parallel to each other.

The third common sides and the fourth common sides may not be parallel to each other.

The first common sides and the second common sides may not be parallel to each other, and the third common sides and the fourth common sides may not be parallel to each other.

The sum of areas of any two neighboring rectangles among the first rectangles may be the same as the sum of areas of other two neighboring rectangles.

The sum of areas of any two neighboring rectangles among the second rectangles may be the same as the sum of areas of other two neighboring rectangles.

The sum of areas of any two neighboring rectangles among the first rectangles may be the same as the sum of areas of other two neighboring rectangles and the sum of areas of any two neighboring rectangles among the second rectangles may be the same as the sum of areas of other two neighboring rectangles.

The touch panel may further include a transparent substrate with the electrode formed thereon.

The electrode may be formed by copper (Cu), aluminum (Al), gold (Au), silver (Ag), titanium (Ti), palladium (Pd), chrome (Cr), or combinations thereof.

The electrode may be formed by metallic silver formed by exposing/developing a silver salt emulsion layer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view of a touch panel according to a preferred embodiment of the present invention;

FIG. 2 is an enlarged diagram acquired by enlarging area A illustrated in FIG. 1;

FIG. 3 is an enlarged diagram illustrating another example of an electrode pattern illustrated in FIG. 1; and

FIGS. 4 and 5 are plan views illustrating a state in which a black matrix pattern of a color filter is overlapped with the electrode pattern of FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

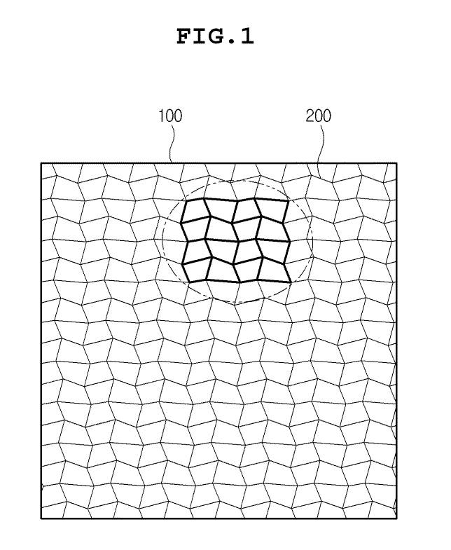

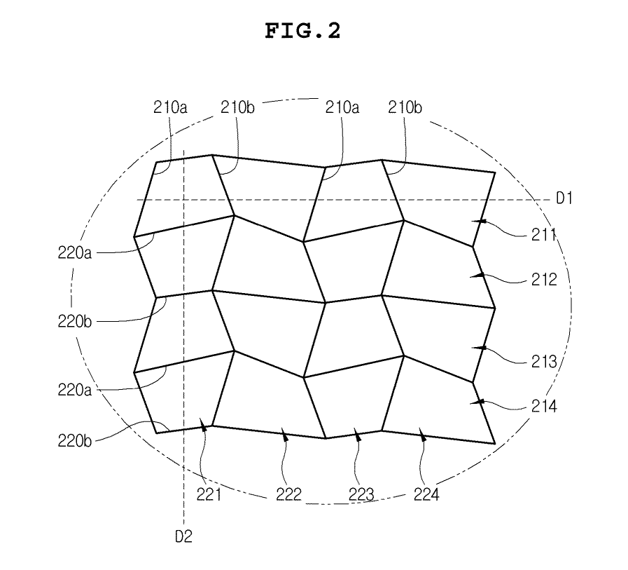

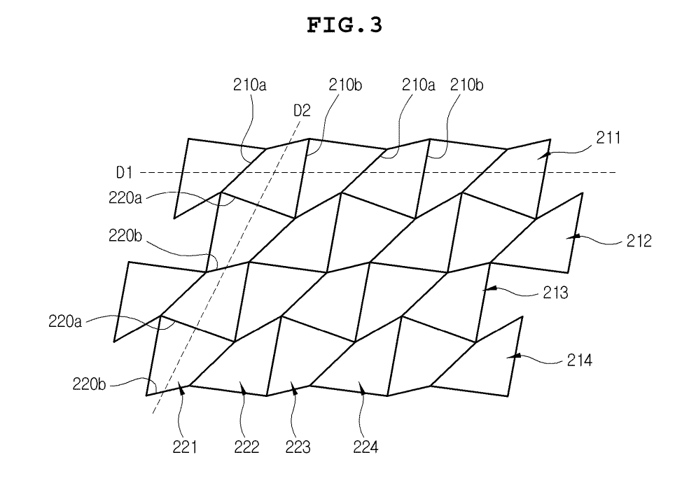

FIG. 1 is a plan view of a touch panel according to a preferred embodiment of the present invention, FIG. 2 is an enlarged diagram acquired by enlarging area A illustrated in FIG. 1, and FIG. 3 is an enlarged diagram illustrating another example of an electrode pattern illustrated in FIG. 1.

As illustrated in FIG. 1, the touch panel according to the preferred embodiment includes an electrode 200 formed in a pattern including continuous rectangles.

The electrode 200 serving to allow a controller to recognize a touch coordinate by generating a signal when the electrode 200 is touched by a user may be formed on a transparent substrate 100.

Herein, the electrode 200 may be formed by copper (Cu), aluminum (Al), gold (Au), silver (Ag), titanium (Ti), palladium (Pd), chrome (Cr), or combinations thereof. In this case, the electrode 200 may be formed by a plating process or an evaporation process using a sputter.

The electrode 200 may be formed by metallic silver formed by exposing/developing a silver salt emulsion layer in addition to the metal.

Meanwhile, the pattern forming the electrode 200 includes the continuous rectangles. The rectangles include first rectangles 211, 212, 213, 214, etc. that are continuous in a first direction D1, and second rectangles 221, 222, 223, 224, etc. that are continuous in a second direction D2 are formed while the first rectangles are continuous in the second direction D2.

In the first rectangles 211, 212, 213, 214, etc., common sides are formed among the rectangles as illustrated in FIG. 3. The common sides formed among the first rectangles 211, 212, 213, 214, etc. are constituted by a first common side 210a and a second common side 210b, and in this case, the first common side 210a and the second common side 210b are alternately formed.

It is the same with respect to even with respect to the second rectangles 221, 222, 223, 224, etc. Even in the case of the second rectangles 221, 222, 223, 224, etc., the common sides are formed among the rectangles, and the common sides are constituted by a third common side 220a and a fourth common side 220b. The third common side 220a and the fourth common side 220b are alternately formed.

Meanwhile, the first common sides 210a formed among the second common sides 210b have the same length as each other and are parallel to each other. The second common sides 210b formed among the first common sides 210a have the same length as each other and are parallel to each other. The first common side 210a and the second common side 210b may be the same as each other or different from each other in length.

However, the first common side 210a and the second common side 210b may not be parallel to each other. When the first common side 210a and the second common side 210b are parallel to each other, in the case of the second rectangles 221, 222, 223, 224, etc., the sides of the rectangles may be connected in a straight line.

In this case, in the pattern of the electrode 200, continuous lines may be formed straightly in any one direction. The pattern of the electrode 200 is overlapped with a pattern of a black matrix 10 of a color filter, and as a result, a Moire phenomenon may occur. Therefore, the first common side 210a and the second common side 210b may not be parallel to each other.

The third common sides 220a formed among the fourth common sides 220b have the same length as each other and are parallel to each other. The fourth common sides 220b formed among the third common sides 220a have the same length as each other and are parallel to each other. The third common side 220a and the fourth common side 220b may be the same as each other or different from each other in length.

However, for the same reason that the first common side 210a and the second common side 210b are not parallel to each other, the third common side 220a and the fourth common side 220b may not be parallel to each other.

In other words, when the third common side 220a and the fourth common side 220b are parallel to each other, in the case of the first rectangles 211, 212, 213, 214, etc., the sides of the rectangles may be connected in the straight line. In this case, in the pattern of the electrode 200, the continuous line may be formed straightly in any one direction. The pattern of the electrode 200 is overlapped with the pattern of the black matrix 10 of the color filter, and as a result, the Moire phenomenon may occur. Therefore, the third common side 220a and the fourth common side 220b may not be parallel to each other.

In the pattern of the electrode 200 formed as above, two other first rectangles 211 and 213 positioned at both sides of any one first rectangle 212 in the second direction D2 have the same shape as each other.

Two other second rectangles 221 and 223 positioned in the first direction D1 at both sides of any one second rectangle 222 have the same shape as each other.

The sum of areas of any two neighboring rectangles among the rectangles included in the first rectangles 211, 212, 213, 214, etc. is the same as the sum of areas of two other rectangles.

The sum of areas of any two neighboring rectangles among the rectangles included in the second rectangles 221, 222, 223, 224, etc. is the same as the sum of areas of two other rectangles.

Therefore, according to the preferred embodiment, an aperture ratio per unit area may be constantly maintained in the pattern of the electrode 200, and as a result, uniform electrical conductivity and visuality of the touch panel according to the preferred embodiment may be ensured.

Meanwhile, in FIG. 2, the first direction D1 which is the length direction of the first rectangles 2111, 212, 213, 214, etc. and the second direction D2 which is the length direction of the second rectangles 221, 222, 223, 224, etc. cross each other substantially perpendicularly. However, the first direction D1 and the second direction D2 do not particularly perpendicularly cross each other.

FIG. 3 illustrates another example of the pattern of the electrode 200 illustrated in FIGS. 1 and 2. The example of the pattern of the electrode 200 illustrated in FIG. 3 illustrates an example in which the first direction D1 and the second direction D2 does not perpendicularly cross each other as the lengths and the length directions of the first common side 210a, the second common side 210b, the third common side 220a, and the fourth common side 220b are changed.

As the pattern of the electrode 200 according to the preferred embodiment includes the aforementioned rectangles, a line connecting the common sides is formed in zigzag in the length direction, and as a result, the continuous straight line is not formed in any direction in the pattern of the electrode 200.

On the contrary, the pattern of the black matrix 10 of the color filter provided in the image display device (LCD, and the like) generally the straight line which is continuous in a horizontal direction and a vertical direction while forming a periodic lattice structure. Therefore, the periodic characteristics of the pattern of the electrode 200 and the pattern of the black matrix 10 are not overlapped with each other, and as a result, the touch panel according to the preferred embodiment may prevent the Moire phenomenon from occurring.

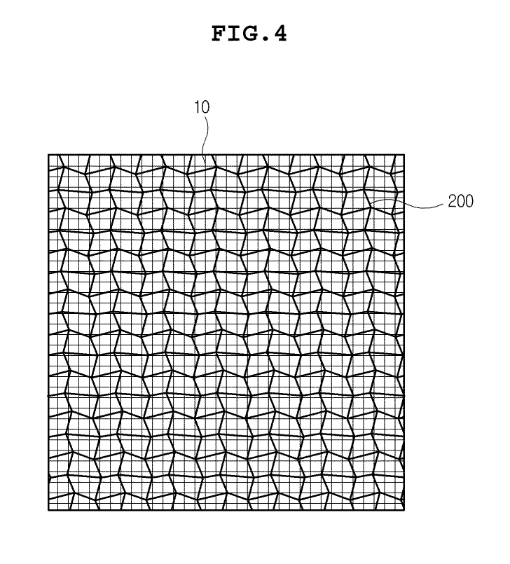

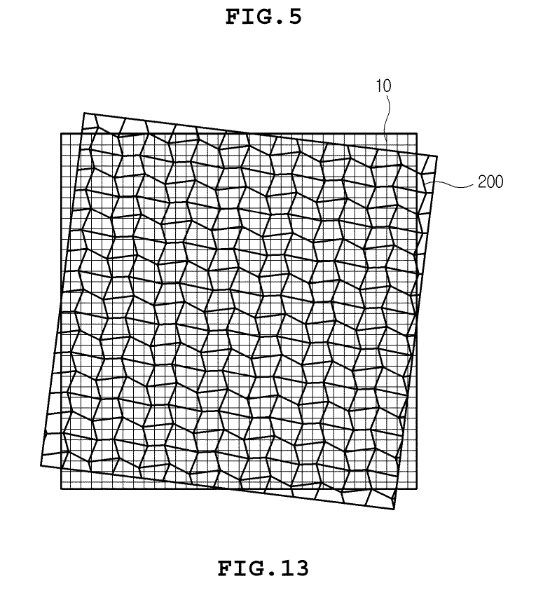

In more detail, referring to FIGS. 4 and 5, the case in which the Moire phenomenon does not occur will be described below.

FIGS. 4 and 5 are plan views illustrating a state in which the black matrix pattern of the color filter is overlapped with the electrode pattern of FIG. 1.

As illustrated in FIG. 4, the pattern of the electrode 200 does not have the straight line which is continuous in any direction. On the contrary, the pattern of the black matrix 10 of the color filter provided in the image display device (LCD, and the like) has a line which is continuous in the horizontal and vertical directions while forming the periodic lattice structure.

Accordingly, although the pattern of the electrode 200 and the pattern of the black matrix 10 are overlapped with each other, occurrence of an interference phenomenon may be minimized, and as a result, the Moire phenomenon may be prevented.

Further, as illustrated in FIG. 5, although the patterns are rotated at a predetermined angle while the pattern of the electrode 200 and the pattern of the black matrix 10 are overlapped with each other, the occurrence of the interference phenomenon may also be minimized, and as a result, the Moire phenomenon may be prevented.

Meanwhile, the electrode 200 may be formed on the transparent substrate 100, and herein, the transparent substrate 100 needs to have support force to support the electrode 200 and transparency that allows a user to recognize an image provided in the image display device. By considering the support force and the transparency, the transparent substrate 100 may be formed by polyethyleneterephthalate (PET), polycarbonate (PC), polymethylmethacrylate (PMMA), polyethylenenaphthalate (PEN), polyethersulfone (PES), cyclo olefin copolymer (COC), a triacetylcellulose (TAC) film, a polyvinyl alcohol (PVA) film, a polyimide (PT) film, polystyrene (PS), biaxially oriented polystrylene (BOPS, containing a K resin), glass or tempered glass, but is not particularly limited thereto.

Additionally, high-frequency processing or primer processing may be performed in order to activate the transparent substrate 100. As such, bonding force between the transparent substrate 100 and the electrode 200 may be improved by activating the transparent substrate 100.

The transparent substrate 100 may be a window provided at an outermost side of the touch panel. When the transparent substrate 100 is the window, the electrode 200 is directly formed in the window, and as a result, a manufacturing process can be simplified by omitting a process of forming the electrode 200 on the additional transparent substrate 100 and thereafter, attaching the electrode 200 to the window, and the entire thickness of the touch panel can be reduced.

According to the exemplary embodiments of the present invention, since the electrode pattern does not have a continuous line even in any direction, the Moire phenomenon can be prevented from occurring in the touch panel, and as a result, the visibility of the touch panel can be improved.

Further, according to the exemplary embodiments of the present invention, an aperture ratio per unit area of the electrode pattern can be maintained constantly, and as a result, the uniform electrical conductivity and visuality of the touch panel can be ensured.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
an electrode formed in a pattern including continuous rectangles,
wherein in first rectangles which are continuous in a first direction among the rectangles, first common sides and second common sides are alternately formed among the first rectangles,
in second rectangles which are continuous in a second direction among the rectangles, third common sides and fourth common sides are alternately formed among the second rectangles, and
the first common sides, the second common sides, the third common sides, and the fourth common sides are parallel to each other and have the same length as each other.

2. The touch panel as set forth in claim 1, wherein the first common sides and the second common sides are not parallel to each other.

3. The touch panel as set forth in claim 1, wherein the third common sides and the fourth common sides are not parallel to each other.

4. The touch panel as set forth in claim 1, wherein the first common sides and the second common sides are not parallel to each other, and
the third common sides and the fourth common sides are not parallel to each other.

5. The touch panel as set forth in claim 1, wherein the sum of areas of any two neighboring rectangles among the first rectangles is the same as the sum of areas of other two neighboring rectangles.

6. The touch panel as set forth in claim 1, wherein the sum of areas of any two neighboring rectangles among the second rectangles is the same as the sum of areas of other two neighboring rectangles.

7. The touch panel as set forth in claim 1, wherein the sum of areas of any two neighboring rectangles among the first rectangles is the same as the sum of areas of other two neighboring rectangles, and
the sum of areas of any two neighboring rectangles among the second rectangles is the same as the sum of areas of other two neighboring rectangles.

8. The touch panel as set forth in claim 1, further comprising:
a transparent substrate with the electrode formed thereon.

9. The touch panel as set forth in claim 1, wherein the electrode is formed by copper (Cu), aluminum (Al), gold (Au), silver (Ag), titanium (Ti), palladium (Pd), chrome (Cr), or combinations thereof.

10. The touch panel as set forth in claim 1, wherein the electrode is formed by metallic silver formed by exposing/developing a silver salt emulsion layer.
